(19) United States
(12) Patent Application Publication
(10) Pub. No.: US 2025/0121695 A1
(43) Pub. Date: Apr. 17, 2025

(54) INTEGRATED END HORN FOR PANTOGRAPH ASSEMBLY

(71) Applicant: Caterpillar Inc., Peoria, IL (US)

(72) Inventors: Richard Eugene Hogan, Dunlap, IL (US); Eric Ruth, Peoria, IL (US)

(73) Assignee: Caterpillar Inc., Peoria, IL (US)

(21) Appl. No.: 18/380,927

(22) Filed: Oct. 17, 2023

(51) Int. Cl. B60L 5/24; B60L 9/00

(52) U.S. Cl. CPC B60L 5/24; B60L 9/00; B60L 2200/40

(57) ABSTRACT

A pantograph assembly for a work machine is disclosed. The pantograph assembly is used to transfer electrical power from an overhead conductor to the work machine and includes a pantograph support that is connected to the work machine and an articulated assembly used to raise and lower a connected pan rail assembly of the pantograph assembly. A first insert piece is inserted into a first pan rail of the pan rail assembly, and the first insert piece is used to support a tubular end horn. The pan rail assembly is connected to an end horn assembly that includes a non-metallic first insert piece that is connected to the pan rail assembly. The first insert piece is used to connect a tubular end horn of the end horn assembly to the pan rail assembly.

### TECHNICAL FIELD

The present disclosure generally relates to trolley-assist work machines, and more particularly to end horns for a pantograph assembly for trolley-assist work machines.

### BACKGROUND

Work machines such as trolley-assist work machines or electric locomotives generally employ a pantograph assembly to provide electrical power to the work machine. Typically, the pantograph assembly is carried on a top surface of the work machine. The pantograph assembly is configured to draw power from an overhead conductor and transfer it to the work machine. Typically, the pantograph assembly includes a carbon brush on a pan rail and an end associated with the carbon brush. During normal operation, the overhead conductor is in contact with the conducting carbon brush. However, in case of an off highway work machine, such as an off road large mining truck, when the pantograph is raised and lowered to make a connection with the overhead conductors there is an increased possibility for line damage if the pantographs are commanded to raise when misaligned due to the lateral movements of the off highway work machines compared to a locomotive.

U.S. Pat. No. 8,944,227 (hereinafter, the '227 patent) discloses a pantograph having an end horn connected to a carbon brush of a pantograph assembly. A bridge portion of the end horn is connected to the carbon brush that has an arcuate profile that includes a top surface that rises above a longitudinal plane of a contact surface of the carbon brush. The bridge portion includes two vertical plate members that sandwich an end of a pan rain and the carbon brush. However, the '227 patent does not address situations where the pantograph is misaligned prior to lateral movements of a work machine.

While effective, there remains a need for improved dipper designs for work machines used in high wear applications, such as construction and mining.

### SUMMARY

In accordance with one aspect of the present disclosure, a pantograph assembly that is used to transfer electrical power from an overhead conductor to a work machine is disclosed. The pantograph assembly has a pantograph support that is attached to the work machine. An articulated assembly is used to raise or lower a pan rail assembly of the pantograph assembly. The pan rail assembly has a pan rail that is supported by the articulated assembly along a longitudinal axis of the pan rail. The pan rail assembly is connected to an end horn assembly that includes a non-metallic first insert piece that is connected to the pan rail. The first insert piece is used to connect a tubular end horn of the end horn assembly to the pan rail.

In accordance with another aspect of the present disclosure, a work machine that has a pantograph assembly is disclosed. The pantograph assembly is used to transfer electrical power from an overhead conductor to the work machine for assisting in the propulsion of the work machine. A pantograph support is connected to the work machine and is also connected to a first link of an articulated assembly. A second link of the articulated assembly is hingedly connected to the first link. A pan rail assembly is supported by the second link and has a first pan rail and a second pan rail extending parallel to a longitudinal axis. A non-metallic first insert piece is connected to the first pan rail along with a second insert piece connected to the second pan rail. A tubular end horn is connected to the first piece at a first end, and is connected to the second insert piece at a second end.

In accordance with another aspect of the present disclosure, an end horn assembly for a pantograph is disclosed. The pantograph is used to transfer electrical power from an overhead conductor to a work machine, and includes a first pan rail and a second pan rail that are supported by an articulated assembly, which itself is connected to a pantograph support for connecting the pantograph to a work machine. The end horn assembly has a first insert piece that is inserted into the first pan rail and a second insert piece that is inserted into the second pan rail. A partially metallic tube that is connected to the first insert piece at a first end and connected to the second insert piece at a second end has a parallel portion and a bent portion. The parallel portion is parallel to a longitudinal axis of the first pan rail and the second pan rail, and the bent portion is slanted downwards relative to the longitudinal axis.

These and other aspects and features of the present disclosure will be more readily understood when read in conjunction with the accompanying drawings.

### BRIEF DESCRIPTION OF THE DRAWINGS

FIG. 1 is a diagrammatic illustration of a work machine having a pantograph.

FIG. 2 is a perspective view of an exemplary pantograph assembly, in accordance with the present disclosure.

FIG. 3 is a perspective view of a pan rail assembly of the pantograph assembly of FIG. 2, in accordance with the present disclosure.

FIG. 4 is a side view of an end horn assembly of the pan rail assembly of FIG. 3, in accordance with the present disclosure.

FIG. 5 is a perspective view of the end horn assembly of FIG. 4, in accordance with the present disclosure.

FIG. 6 is perspective view of an end horn of the end horn assembly of FIG. 4, in accordance with the present disclosure.

FIG. 7 is perspective view of an insert piece of the end horn assembly of FIG. 4, in accordance with the present disclosure.

### DETAILED DESCRIPTION

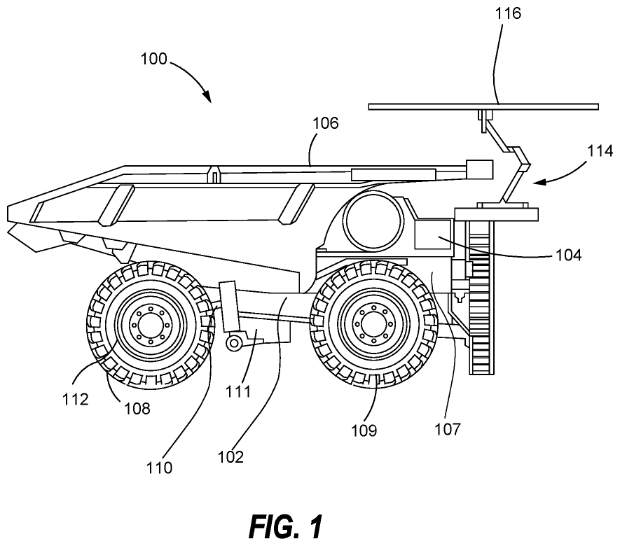

Referring to FIG. 1, a side view of a work machine is shown, according to an aspect of the present disclosure. The work machine 100 may include a vehicle such as an off-highway truck, or other vehicle used in mining, construction, quarrying, and other applications. One example of the work machine 100 is the off-highway truck including a chassis 102 that supports an operator cab 104 and a bucket 106. The bucket 106 may be connected to the chassis 102 and arranged to carry a payload. The work machine 100 may include a power source 107, for example, but not limited to, an engine (internal combustion, gas, diesel, gaseous fuel, natural gas, propane, etc.), may be of any size, with any number of cylinders, and in any configuration (“V,” in-line, radial, etc.). The chassis 102 also supports various other drive system components. These drive system components are capable of driving a set of drive wheels 108 to propel the work machine 100. A set of idle wheels 109 can steer such that the work machine 100 may move in any direction.

In the illustrated embodiments, the power source 107 may produce an output torque at an output shaft 110. The output shaft 110 of the power source may be connected to a generator 111. In operation, the output shaft 110 of the power source 107 rotates a rotor (not shown) of the generator to produce electrical power to drive motors 112 associated with the drive wheels 108. The motors 112 may be connected via intermediate assemblies or directly to drive wheels 108 of the work machine 100. A person skilled in the art will understand that the generator may produce electric power in the form of alternating current (AC) power. This electrical power is supplied to a rectifier and converted to direct current (DC) power. The rectified DC power may be converted again to an AC power by an inverter circuit. The inverter circuit may be capable of selectively adjusting the frequency and/or pulse-width of its output, such that the motors 112 may be operated at variable speeds.

The work machine 100 further includes the pantograph assembly 114 mounted on the work machine 100. Alternatively, a pair of pantograph assemblies may be mounted side by side on the work machine 100. The pantograph assembly 114 may be configured to supply electrical power from an overhead conductor 116 to the work machine 100. The electrical power from the overhead conductor 116 may act as an auxiliary power source to assist in propulsion of the work machine 100. During operation, the pantograph assembly 114 may shortcut the power source 107 and the generator 111 thereby providing electrical power directly to the drive motors 112.

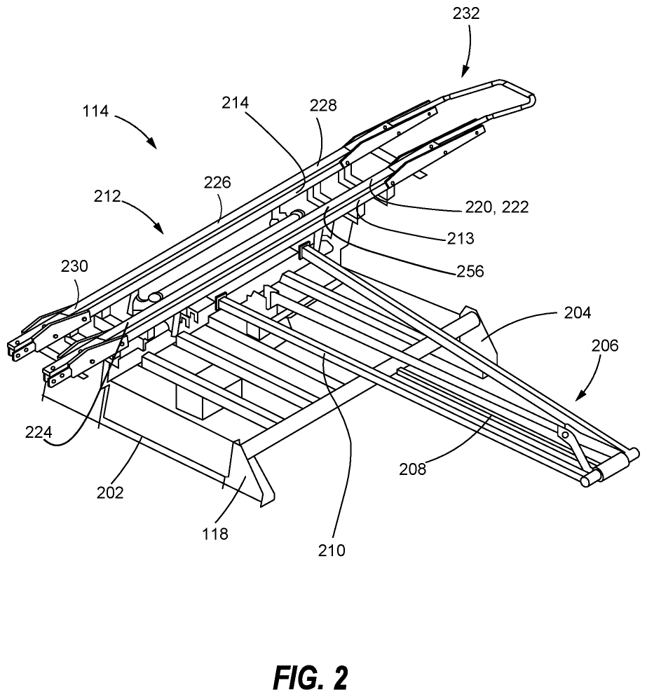

Referring now to FIG. 2, the pantograph assembly 114 includes a pantograph support 118 having a pair of legs 202 and 204. The pair of legs 202 and 204 may be mounted on a front of the work machine 100 for example by using nut and bolts. Insulating members (not shown) may be provided at the pair of legs 202 and 204. The insulting members may be designed to keep the pantograph support 118 electrically insulated from the work machine 100.

An articulated assembly 206 may be connected to the pantograph support 118. The articulated assembly 206 includes a first link 208 hingedly connected to the pantograph support 118 and a second link 210 hingedly connected to the first link 208. The hinged connection of the first link 208 with the second link 210, enables tilting of the first link 208 with respect to the second link 210.

In an embodiment of the present disclosure, the first link 208 and the second link 210 may include a hydraulic or compressed air based piston-cylinder mechanism (not shown) to affect the tilting movement of the first link 208 with respect to the second link 210. Alternatively, a tie rod may connect one of the first link 208 and the second link 210, and may be configured to cause the tilting movement of the first link 208 with respect to the second link 210. The second link 210 may be connected to a pan rail assembly 212, and specifically, a first pan rail 213 such that the pan rail 213 is supported on the second link 210 of the articulated assembly 206. In an alternative embodiment of the present disclosure, the second link 210 may be connected to the pan rail assembly 212 that includes a pair of pan rails, such as the first pan rail 213 and a second pan rail 214.

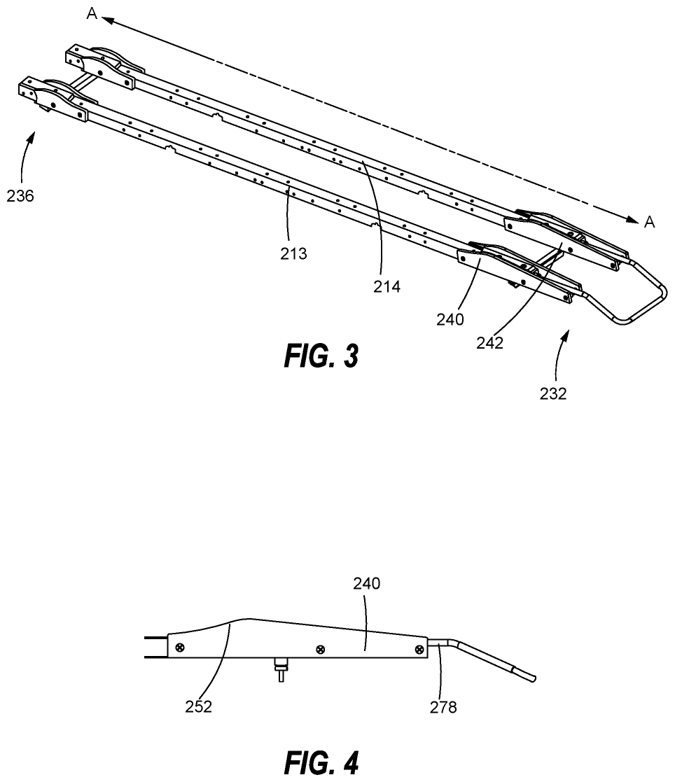

As shown in FIGS. 2 and 3, the pan rails 213 and 214 extend along, or parallel to, a longitudinal axis AA′. Auxiliary rails (not numbered) may span along the pan rails 213 and 214, to provide rigidity to the pan rails 213 and 214. Further, support brackets may be provided to interconnect the pan rails 213 and 214. In one exemplary embodiment, a first carbon brush 220 may be supported by the pan rail 213, along the longitudinal axis AA′. The first carbon brush 220 includes a first end portion 222 and a second end portion 224 opposite to the first end portion 222 along the longitudinal axis AA′. In an embodiment of the present disclosure, a pair of carbon brushes including the first carbon brush 220 and second carbon brush 226 may be supported by the pair of pan rails 213, 214, respectively. The second carbon brush 226 also includes a first end portion 228 and a second end portion 230. The articulated assembly 206, in one exemplary embodiment, is used to raise or lower the pan rail assembly 212 of the pantograph assembly 114, and the first pan rail 113, and/or second pan rail 114, is supported by the articulated assembly 206 along the longitudinal axis AA′.

As shown in FIGS. 2 and 3, the pantograph assembly 114 further includes an end horn assembly 232 connected to the first pan rail 213 and the second pan rail 214. The end horn assembly 232, or first end horn assembly 232, may be composed, or partially composed of, an electrically non-conducting material, such that the overhead conductor 116 may contact the end horn assembly 232 and slide thereon before contacting the carbon brush 220. In the present disclosure, the pantograph assembly 114 also includes another end horn assembly 236, or second end horn assembly 236, connected to the first pan rail 213 and the second pan rail 214, with the second end horn assembly 236 connected at an opposite end of the pan rail assembly 212 as the first end horn assembly. It will be apparent to a person skilled in the art that the end horn assemblies 232, 236 may be structurally similar, and the present disclosure will be described with reference to only one end horn, the end horn 232.

Referring to FIG. 3 through FIG. 5, the end horn assembly 232 includes bridge portions, such as first bridge portion 240, and second bridge portion 242, respectively. The first bridge portion 240 may be integral, or connected to the end of, to the first pan rail 213 along the longitudinal axis AA′, and the second bridge portion 242 may be integral with the second pan rail 214 along the longitudinal axis AA′. It will be apparent to a person skilled in the art that the bridge portions 240, 242 may be structurally similar, and the remainder of the present disclosure will be described with reference to only the first bridge portion 240. The first bridge portion 240 of then horn assembly 232 may include a first plate member 248 and a second plate member 250 opposite the first plate member 248 with the second plate member 250 having an arcuate profile. The first and the second plate member 248, 250 may include notched portion 252 and 254, respectively, configured to receive the first end portion 222 of the carbon brush 220. The notched portions 252 and 254 may abut a top surface 256 (FIG. 2) of the carbon brush 220 such that the arcuate profile of the first and the second plate members 248, 250 may be aligned with the top surface 256.

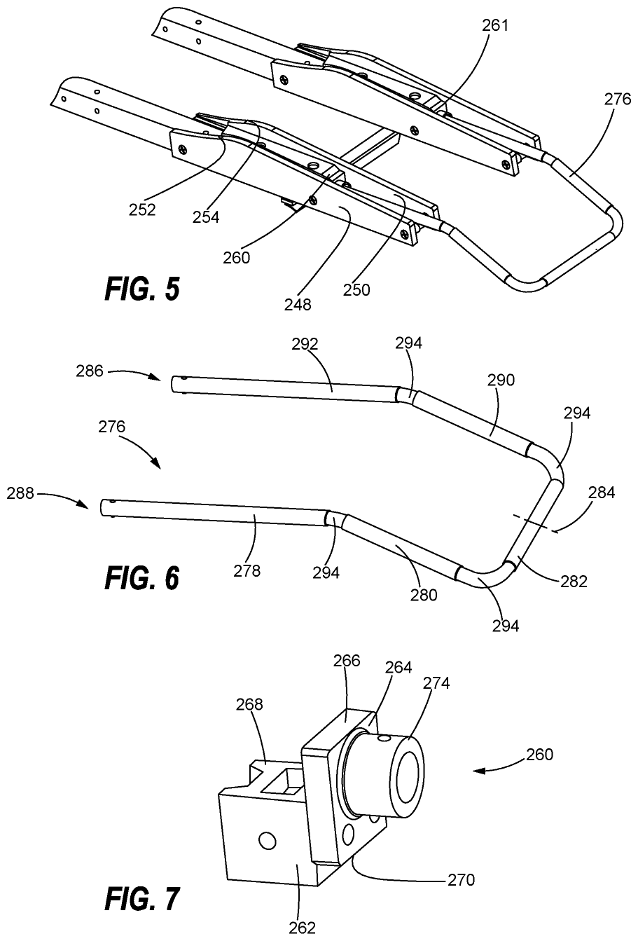

As shown in FIGS. 5 and 7, the first end horn assembly 232 of the pan rail assembly 212 of the pantograph assembly 114 further includes a non-metallic first insert piece 260 insertably connected to the end of first pan rail 213 along the longitudinal axis AA′. Similarly, a second non-metallic insert piece 261 is insertably connected to the end of the second pan rail 214 along the longitudinal axis AA′. As a person of ordinary skill in the art would understand the first and second insert pieces 260, 261 may be structurally similar, the structure of the first insert piece will be described. The first insert piece 260 includes a base portion 262 for insertion into the end of the first pan rail 213 along the longitudinal axis AA′ for connecting the first insert piece 260 to the first pan rail 213. An elevated portion 264 of the first insert piece 264 may be attached to the end of the base portion 262, along the longitudinal axis AA′, and has a top surface 266 that rises above, in a direction perpendicular to the longitudinal axis AA′, a top surface 268 of the base portion 262. Further, the elevated portion 264 includes a bottom surface 270 that rises above, also relative to the longitudinal axis AA′, a bottom surface 274 of the base portion 262. The first insert piece 260 also has a tubular shaped connection portion 274 that is connected to and extends outwardly, along the longitudinal axis AA′, from the elevated portion 264. The first insert piece 260, and thus, the second insert piece 261, may be constructed of an additive manufacturing, or 3D printing technique, and constructed as a single piece. The insert pieces 260, 261 are constructed of a material that does not conduct electricity, such as a polymer, rubber, porcelain, ceramic or the like.

Further shown in FIGS. 6 through 6, the first end horn assembly 232 of the pan rail assembly 212 of the pantograph assembly 114 further includes an end horn 276 that connects to the first insert piece 260 and the second insert piece 261, extending away from pan rails 213, 214 along the longitudinal axis AA′. The end horn 276, in one exemplary embodiment, has a symmetrical shape, and thus, any cited portions of a first half 286 (discussed below) of the end horn 276 in the following description may be applied to describe the other identical half (second half 288 described below) of the end horn 276. The end horn 276 may be constructed as a hollow tubular object, or in another exemplary embodiment, is constructed as a solid tubular object. The end horn 276 may be constructed of a non-metallic material, or at least, is constructed as partially non-metallic. However, in a further exemplary embodiment, the end horn 276 is constructed from a bent metal tube as the insert pieces are non-metallic, thus allowing for a metallic end horn 276 that would not transfer electricity to the remainder of the pantograph assembly 114 as electricity would not pass from the metallic end horn 276 to the non-metallic insert pieces 260, 261.

As shown in detail in FIGS. 4 and 6, the end horn 276 has a first portion 278 insertable and connected to the connection portion 274 of the first insert piece 260 at one end and extending away from the first insert piece 260 along the longitudinal axis AA′ at its opposite end. In another exemplary embodiment, the connection portion 274 is instead inserted into the end of the first portion 278 for connecting the end horn 276. A second portion 280 of the end horn 276 tilts downwards, relative to the longitudinal axis AA′, away extending away from the first portion 278. A third portion 282 of the end horn 276 extends, in a perpendicular direction to the longitudinal axis AA′, from the second portion 280 of the end horn. A midway point of the of the third portion 282 defines the line of symmetry 284 of the end horn 276 between the first half 286 of the end horn 276 that connects to the first insert piece 260 and the second half 288 of the end horn 276 that connects to the second insert piece 261.

Turning to FIG. 6, the second half 288 of the end horn 276 includes a fourth portion 290 of the end horn 276 that is slanted upwards, relative to its connected third portion 282, and a fifth portion 292 that extends along the longitudinal axis AA′ for connecting the second half 288 of the end horn 276 to the second insert piece 261.

In one exemplary embodiment, the first portion 278, second portion 280, third portion 282, fourth portion 290, and fifth portion 292 of the end horn 276 are constructed of a metallic tube, such as steel. In this exemplary embodiment, in between the portions 278, 280, 282, 290, 292 are bent portions 294 that are non-metallic for connecting the two adjacent portions 278, 280, 282, 290, 292. In another exemplary embodiment, the bent portions 294 are also metallic, and are connected to the portions 278, 280, 282, 290, 292 through a method such as welding or the like. In the FIG. 6 embodiment, the bent portions 294 are shown having a smaller diameter than the portions 278, 280, 282, 290, 292, as this would aide in construction of the end horn 276 when the end horns hard hollow tubular objects as the bent portions 294 may be inserted into the portions 278, 280, 282, 290, 292 for connecting. However, in another exemplary embodiment, the bent portions 294 may have a larger diameter than the portions 278, 280, 282, 290, 292.

In another exemplary embodiment, the end horn 276 is constructed of a singular metallic tube that is bent to from the end horn 276, and the bent portions 294 of the end horn are a continuation of the metallic tube 276. In this embodiment, the end horn 276 may have a constant diameter throughout all portions of the end horn 276 as opposed to the FIG. 6 embodiment, which depicts the portions 278, 280, 282, 290, 292 having a larger diameter than the bent portions 294.

### INDUSTRIAL APPLICABILITY

In general, the teachings of the present disclosure may find applicability in many industries including, but not limited to, mining, or any operation of a vehicle requiring an overhead conductor, such as the overhead conductor 116 positioned along a travel path. The overhead conductor 116 may come in electrical contact with the pantograph assembly 114 to provide electrical contact with the pantograph assembly 114 to provide electrical power to the work machine 100. Particularly, the overhead conductor 116 may be in contact with the carbon brushes, such as carbon brush 220. However, when the pantograph 114 is raised, due to misalignment of the pantograph with the overhead conductor or lateral movement of the work machine 100, line damage is possible if a portion of the pantograph 114 applies force to the overhead assembly 116 besides the carbon brushes 220. Further, conventionally, the transition of the overhead conductor 116 between any non-conducting end horns and the conducting carbon brushes may cause arcing. In an embodiment of the present disclosure, the end horn 276 is integrally formed with the end horn assembly 232 may preclude the arcing thereby saving the carbon brushes 220 from getting damaged. Further, the end horn 276 allows the overhead conductor to slide onto the carbon brushes 220 to aide in alignment and contact of the overhead conductor 116 with the carbon brushes 220.

As described above, the use of a non-metallic insert piece 260, 261 is used to hold the bent end horn 276. Since the insert pieces 260, 261 are non-metallic, and the end horn 276 is connected to the pantograph solely through the insert pieces 260, 261, a metallic, or partially metallic, end horn 276 may be used without transferring electricity to the remainder of the pantograph 114. The use of metal allows for easy fabrication of the end horn 276 and for high durability. The insert pieces 260, 261 utilize a vertically offset, relative to the longitudinal axis AA′, design to be strongest when forces from the overhead conductor 116 are applied from above when the pantograph 114 is raised to contact the overhead conductor 116. The insert pieces 260, 261 are designed to use existing fastener locations of the pan rails 213, 214 for retrofitting existing pantographs 114.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

What is claimed is:

1. A pantograph assembly configured to transfer electrical power from an overhead conductor to a work machine, the pantograph assembly comprising:
a pantograph support connected to the work machine;
an articulated assembly configured to raise or lower a pan rail assembly of the pantograph assembly;
the pan rail assembly having a first pan rail supported by the articulated assembly along a longitudinal axis of the first pan rail; and
a non-metallic first insert piece insertably connected to the first pan rail, in which the first insert piece is configured to connect a tubular end horn to the pan rail.

2. The pantograph assembly of claim 1, in which the first insert piece includes a base portion configured to be inserted into an end of the first pan rail for connecting the first insert piece to the pan rail.

3. The pantograph assembly of claim 2, in which the first insert piece includes an elevated portion that has a top surface that rises above a top surface of the base portion, relative to the longitudinal axis.

4. The pantograph assembly of claim 3, in which a tubular shaped connection portion of the first insert piece extends outwardly from the elevated portion.

5. The pantograph assembly of claim 1, in which the end horn includes a first portion connected to the first insert piece, the first portion extending away from the first insert piece along the longitudinal axis.

6. The pantograph assembly of claim 5, in which the end horn includes a second portion tilting downwards, relative to the longitudinal axis, from the first portion.

7. The pantograph assembly of claim 6, in which the end horn includes a third portion extending perpendicular to the longitudinal axis from the second portion of the end horn.

8. The pantograph assembly of claim 7, in which the end horn includes a fourth portion that is slanted, relative to the longitudinal axis, and a fifth portion that is parallel, relative to the longitudinal axis.

9. The pantograph assembly of claim 8, in which the fifth portion is connected to a second insert piece, the second insert piece connected to a second pan rail of the pan rail assembly, and the second pan rail is parallel to the first pan rail.

10. The pantograph assembly of claim 9, in which the first, second, third, fourth, and fifth portions are constructed of a steel.

11. The pantograph assembly of claim 10, in which a non-metallic curved material is located between the first portion and the second portion, the second portion and the third portion, the third portion and the fourth portion, and the fourth portion and the fifth portion of the end horn.

12. The pantograph assembly of claim 1, in which the first insert piece is 3D printed.

13. A work machine having a pantograph assembly configured to transfer electrical power from an overhead conductor to the work machine for assisting propulsion of the work machine, the work machine comprising:
a pantograph support detachably connected to the work machine;
an articulated assembly having a first link, and a second link hingedly connected to the first link, the first link being connected to the pantograph support;
a pan rail assembly being supported by the second link of the articulated assembly, the pan rail assembly including a first and second pan rail, the first and second pan rail extending parallel along a longitudinal axis;
a pair of non-metallic insert pieces including a first insert piece insertably connected to the first pan rail, and a second insert piece insertably connected to the second pan rail; and
a tubular end horn connected to the first insert piece at a first end and connected to the second insert piece at a second end.

14. The work machine of claim 13, in which the end horn is a metal tube.

15. The work machine of claim 14, in which the metal tube is bent downwards, relative to the longitudinal axis to form the end horn of the pantograph.

16. The work machine of claim 13, in which the first and second insert pieces are configured to attach to existing fastener location at the ends of the first and second pan rails, respectively.

17. The work machine of claim 16, in which the first and second insert pieces are configured to support a stronger force that is applied from above the longitudinal axis than a force that is applied from below the longitudinal axis.

18. An end horn assembly for a pantograph that is configured to transfer electrical power from an overhead conductor to a work machine, the end horn assembly comprising:
a first insert piece and a second insert piece for insertion into a first pan rail and a second pan rail, respectively, of the pantograph, the first pan rail and the second pan rail are raised and lowered by a connected articulated assembly of the pantograph, the articulated assembly connected to a pantograph support of the pantograph configured to be attached to a work machine;
a partially metallic tube that is connected to the first insert piece at a first end and connected to the second insert piece at a second end, the tube including a parallel portion that is parallel to a longitudinal axis of the first pan rail and the second pan rail, and a bent portion that is slanted downwards relative to the longitudinal axis.

19. The pantograph assembly of claim 18, in which the first and second insert pieces are constructed by an additive manufacturing process.

20. The pantograph assembly of claim 18, in which the tube includes non-metallic portions.
